(19) United States
(12) Patent Application Publication
(10) Pub. No.: US 2025/0343676 A1
(43) Pub. Date: Nov. 6, 2025

(54) SECURITY MANAGEMENT METHOD FOR PASSKEY SERVICE, AND APPARATUS FOR IMPLEMENTING THE SAME

(71) Applicant: SAMSUNG SDS CO., LTD., Seoul (KR)

(72) Inventors: Dong Ho KIM, Seoul (KR); Seung Hoon CHA, Seoul (KR); Jae Hyuk CHO, Seoul (KR); Hong Chul LEE, Seoul (KR); Si Wan BAE, Seoul (KR)

(73) Assignee: SAMSUNG SDS CO., LTD., Seoul (KR)

(21) Appl. No.: 19/195,991

(22) Filed: May 1, 2025

(30) Foreign Application Priority Data
May 3, 2024 (KR) 10-2024-0058939

(51) Int. Cl. H04L 9/08; H04L 9/32

(52) U.S. Cl. CPC H04L 9/0825; H04L 9/0863; H04L 9/3226; H04L 9/3247

(57) ABSTRACT

The present disclosure according to at least one embodiment provides a security management method for a passkey service, the security management method performed by a computing device. The security management method comprises: in response to receipt of an account creation request from a service application, generating, by a passkey agent, a first asymmetric key (VERIFYDATA) for encryption and decryption to be used in a passkey generation process, and storing a first private key of the first asymmetric key in a secure area; and generating, by the passkey agent, a second asymmetric key (WRAPPINGDATA_RSA) to be applied to a protective symmetric key (DATAPROTECTION) to be used in a passkey synchronization process, and storing a second private key of the second asymmetric key in the secure area.

### CROSS-REFERENCE TO RELATED APPLICATION

This application claims priority from Korean Patent Application No. 10-2024-0058939 filed on May 3, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a security management method for a passkey service and an apparatus for implementing the same, and more particularly, to a security management method for a passkey service that provides secure key management during passkey generation and synchronization when providing the passkey service, and an apparatus for implementing the same.

### 2. Description of the Related Art

Conventional password-based user authentication has the drawback that passwords can be easily forgotten, require periodic changes, and are vulnerable to security threats.

To address the problems associated with password-based user authentication methods, there is increasing interest in passkey services, which offer passwordless user account authentication through Fast Identity Online (FIDO), a more convenient alternative.

With passkeys, user authentication for websites or platform-specific applications requiring user registration and login can be easily performed without passwords, using biometric authentication methods such as fingerprint recognition or PIN entry.

Meanwhile, passkey providers that provide passkey services perform the roles of synchronizing and managing generated passkeys. In this process, the generated passkeys need to be authenticated after being synchronized in a secure manner.

Entities with special privileges, such as device manufacturers or platform providers like Google, Apple, Microsoft, and the like, can provide passkey services using a special security system such as Trusted Execution Environment (TEE) or Secure Element (SE). However, other entities must build their own systems with security considerations to provide passkey services.

Therefore, when providing passkey services, there is a need for a technology that can provide passkey service providers with secure security management with privileges equivalent to those of device manufacturers or platform providers, even when the passkey service providers are not device manufacturers or platform providers.

In addition, in the process of generating and synchronizing passkeys, it is necessary to utilize a secure environment or space for key generation and key exchange.

### SUMMARY

One objective of the present disclosure is to provide a security management method for a passkey service and an apparatus for implementing the same, which can enable secure key generation and key management using a secure area of a platform, even for a passkey service provider that is not a device manufacturer or a platform provider.

Another objective of the present disclosure is to provide a security management method for a passkey service and an apparatus for implementing the same, which can prevent attacks via memory by applying an extension to the signature during key exchange in the process of generating and authenticating a passkey.

Yet another objective of the present disclosure is to provide a security management method for a passkey service and an apparatus for implementing the same, which can enhance the level of security by generating an additional key derived from a user's PIN input information during the generation and synchronization of a passkey.

The objectives of the present disclosure are not limited to those mentioned above, and other objectives not explicitly stated will be clearly understood by those skilled in the art based on the following description.

According to an aspect of the present disclosure, there is provided a security management method for a passkey service, the security management method performed by a computing device. The security management method comprises: in response to receipt of an account creation request from a service application, generating, by a passkey agent, a first asymmetric key (VERIFYDATA) for encryption and decryption to be used in a passkey generation process, and storing a first private key of the first asymmetric key in a secure area; and generating, by the passkey agent, a second asymmetric key (WRAPPINGDATA_RSA) to be applied to a protective symmetric key (DATAPROTECTION) to be used in a passkey synchronization process, and storing a second private key of the second asymmetric key in the secure area.

In some embodiments, the method may further comprise delivering, by the passkey agent, a first public key of the first asymmetric key and a second public key of the second asymmetric key to a passkey provider server communicating with the computing device.

In some embodiments, the protective symmetric key may be generated by the passkey provider server, and the security management method may further comprise receiving, by the passkey agent, a key generated by applying, in the passkey provider server, Public Key Cryptography Standards (PKCS) using the protective symmetric key and the second public key of the second asymmetric key, and storing the received key in the secure area.

In some embodiments, the method may further comprise: storing, by the passkey agent, a first key (PIN_INFO) for encryption and a second key (PIN_ID) for verification, in the secure area, the first and second keys being generated using PIN input information of a user; and delivering, by the passkey agent, a symmetric key of the second key to the passkey provider server.

In some embodiments, the method may further comprise generating, by the passkey agent, an attestation (Attestation.Device) for verifying whether the computing device has been hacked, when a hacking attempt on the computing device is identified, and storing the attestation in the secure area, and delivering, by the passkey agent, the attestation to the passkey provider server.

According to another aspect of the present disclosure, there is provided a security management method for a passkey service, the security management method performed by a computing device. The security management method comprises: in response to receipt of a passkey generation request from a service application, generating, by a passkey agent, a private key (PASSKEY_PRIVATEKEY) and a public key (PASSKEY_PUBLICKEY) of a passkey and storing the private and public keys in a secure area, generating, by the passkey agent, an encrypted private key (Encrypted PASSKEY_PRIVATEKEY) of the passkey by performing primary encryption on the private key of the passkey using a key (PIN_INFO) derived from PIN input information of a user, and then performing secondary encryption using a protective symmetric key (DATAPROTECTION) previously stored in the secure area, and delivering, by the passkey agent, the encrypted private key of the passkey to a passkey provider server communicating with the computing device.

In some embodiments, the method may further comprise: adding, by the passkey agent, the public key of the passkey to the passkey generation request, acquiring, by the passkey agent, a signature value obtained by signing a value of data included in the passkey generation request with a private key of an asymmetric key (VERIFYDATA) previously stored in the secure area, generating, by the passkey agent, an extension signature value by including the signature value in an extension, and adding, by the passkey agent, the extension signature value to the passkey generation request and delivering the passkey generation request to the passkey provider server.

In some embodiments, the extension may be a format defined in a Web Authentication (WebAuthn) Application Programming Interface (API) for credentialing public keys.

In some embodiments, the method may further comprise: when verification of the encrypted private key of the passkey delivered to the passkey provider server is completed, receiving, by the passkey agent, a passkey response message from the passkey provider server, and delivering, by the passkey agent, the passkey response message to the service application, wherein the encrypted private key of the passkey is stored in a secure area of the passkey provider server.

In some embodiments, the method may further comprise: performing, by the passkey agent, primary decryption on a key delivered through encryption of the encrypted private key stored in the secure area of the passkey provider server, using the protective symmetric key previously stored in the secure area, performing, by the passkey agent, secondary decryption using a key (PIN_INFO) derived from PIN input information of a user, and synchronizing the passkey through the primary and secondary decryptions.

According to another aspect of the present disclosure, there is provided a security management method for a passkey service, the security management method performed by a computing device. The security management method comprises: in response to receipt of the passkey authentication request from a service application, acquiring, by a passkey agent, a signature value obtained by signing a value of data included in a passkey authentication request with a private key of an asymmetric key previously stored in a secure area, generating, by the passkey agent, an extension signature value by including the signature value in an extension, and generating, by the passkey agent, a response message including a signature value signed with a private key (PASSKEY_PRIVATEKEY) of a pre-registered passkey and transmitting the response message to a passkey server.

In some embodiments, the signature value included in the response message delivered to the passkey server may be verified using a public key of an asymmetric key (VERIFYDATA) previously stored in a passkey provider server.

According to another aspect of the present disclosure, there is provided a computing device, comprising at least one processor, a memory for loading a computer program executed by the at least one processor, and a storage for storing the computer program, wherein the computer program includes instructions for performing operations of: in response to receipt of an account creation request from a service application, generating, by a passkey agent, a first asymmetric key (VERIFYDATA) for encryption and decryption to be used in a passkey generation process and storing a first private key of the first asymmetric key in a secure area; and generating, by the passkey agent, a second asymmetric key (WRAPPINGDATA_RSA) to be applied to a protective symmetric key (DATAPROTECTION) to be used in a passkey synchronization process, and storing a second private key of the second asymmetric key in the secure area.

In some embodiments, the computer program may further include instructions for performing an operation of delivering, by the passkey agent, a first public key of the first asymmetric key and a second public key of the second asymmetric key to a passkey provider server communicating with the computing device.

In some embodiments, the protective symmetric key may be generated by the passkey provider server, and the computer program may further include instructions for performing an operation of receiving, by the passkey agent, a key generated by applying, in the passkey provider server, Public Key Cryptography Standards (PKCS) using the protective symmetric key and the second public key of the second asymmetric key, and storing the received key in the secure area.

In some embodiments, the computer program may further include instructions for performing operations of: storing, by the passkey agent, a first key PIN_INFO for encryption and a second key PIN_ID for verification, in the secure area, the first and second keys being generated using PIN input information of a user; and delivering, by the passkey agent, a symmetric key of the second key to the passkey provider server.

In some embodiments, the computer program may further include instructions for performing operations of: generating, by the passkey agent, an attestation (Attestation.Device) for verifying whether the computing device has been hacked, when a hacking attempt on the computing device is identified, and storing the attestation in the secure area; and delivering, by the passkey agent, the attestation to the passkey provider server.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating the configuration of a system for providing security management for a passkey service according to an embodiment of the present disclosure;

FIG. 2 is a flowchart illustrating a security management method for a passkey service according to an embodiment of the present disclosure;

FIG. 3 is a flowchart illustrating a security management method for a passkey service according to another embodiment of the present disclosure;

FIG. 4 is a flowchart illustrating a security management method for a passkey service according to yet another embodiment of the present disclosure;

FIG. 5 illustrates an exemplary key exchange process between devices for account registration when providing a passkey service, according to some embodiments of the present disclosure;

FIG. 6 illustrates a key exchange process between devices during account registration, with reference to FIG. 5;

FIG. 7 illustrates an exemplary additional key exchange process following the key exchange process in FIG. 5;

FIG. 8 illustrates a key exchange process between devices during account registration, with reference to FIG. 7;

FIG. 9 illustrates an exemplary key exchange process between devices for passkey generation when providing a passkey service according to some embodiments of the present disclosure;

FIGS. 10 and 11 illustrate a key exchange process between devices during passkey generation with reference to FIG. 9;

FIG. 12 illustrates an exemplary key exchange process between devices for passkey authentication when providing a passkey service according to some embodiments of the present disclosure;

FIG. 13 illustrates a key exchange process between devices during passkey authentication with reference to FIG. 12;

FIG. 14 illustrates an exemplary key exchange process between devices for passkey synchronization when providing a passkey service according to some embodiments of the present disclosure; and

FIG. 15 is a block diagram illustrating the hardware configuration of a computing device capable of implementing methods according to embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

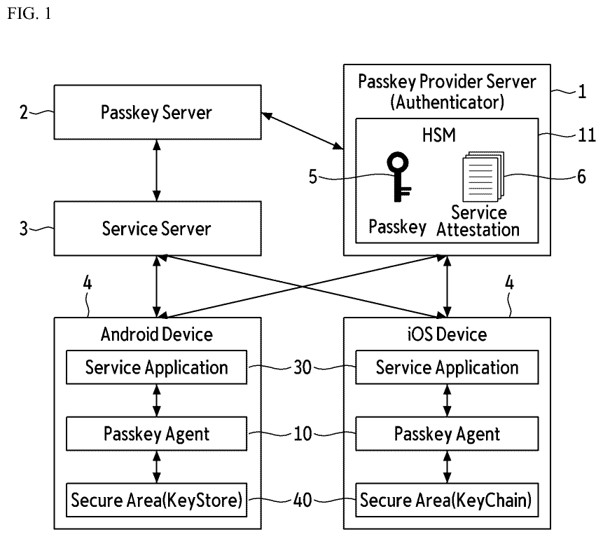

FIG. 1 is a block diagram illustrating the configuration of a system for providing security management for a passkey service according to an embodiment of the present disclosure.

Referring to FIG. 1, the system includes a passkey provider server 1, a passkey server 2, a service server 3, and a plurality of user terminals 4. The user terminals 4 are connected to the passkey provider server 1 and the service server 3 via a network.

Each of the user terminals 4 is a user terminal on which a passkey agent 10 is installed, the passkey agent 10 providing a passkey service for logging into a browser website or a service application 30 in a passwordless manner. The user terminals 4 may be, for example, mobile terminals such as smartphones or tablets, or PCs. The user terminals 4 may be terminals based on an OS platform such as Android, IOS, and the like.

The service server 3, which is a device that provides data and executable files required for the service application 30 installed on each of the user terminals 4, may be, for example, an application server, a cloud server, or a virtual server.

The passkey provider server 1, which is a device that receives and processes a passkey generation request or a passkey authentication request from each of the user terminals 4, may also be an application server, a cloud server, or a virtual server.

In response to a login request from the service application 30 or website on each of the user terminals 4, the passkey provider server 1 processes a passkey generation request or a passkey authentication request from the passkey agent 10. The passkey provider server 1 also provides information regarding a passkey to the passkey agent 10 installed on each of the user terminals 4, and performs passkey management in conjunction with the passkey agent 10.

The passkey server 2 verifies a request for passkey generation or authentication request and the result of processing the request. To this end, the passkey server 2 exchanges messages and data with the passkey provider server 1 and the service server 3. The passkey server 2 may be, for example, an application server, a cloud server, or a virtual server.

The passkey agent 10 performs key management using various asymmetric keys generated during the account creation for user registration, passkey generation, and passkey authentication, utilizing secure areas 40 of the user terminals 4 and the high-speed memory (HSM) 11 of the passkey provider server 1. At this time, each of the secure areas 40 of the user terminals 4 may be, for example, Android Keystore or iOS Keychain.

Accordingly, when providing a passkey service, key exchange and key management may be performed using secure spaces with a high level of security on both the user terminals 4 and the passkey provider server 1.

In addition, the passkey agent 10 may perform key exchange by including, in an extension, a signature value obtained by signing data included in a request message with a private key during passkey generation and passkey authentication. At this time, the data included in the request message may be a distinguishing value that changes for each request, such as, for example, a hash or a challenge.

Accordingly, by linking the extension, which can be freely added depending on the passkey specification, with security, it is possible to improve the level of security, such as by preventing attacks through memory.

The passkey agent 10 may also perform additional user verification using a key derived from PIN input information entered by the user during account registration, passkey generation, and passkey synchronization.

Accordingly, additional verification using the user's PIN input information can be performed not only during initial user registration on the corresponding user terminal 4, but also during passkey generation, thereby enhancing security.

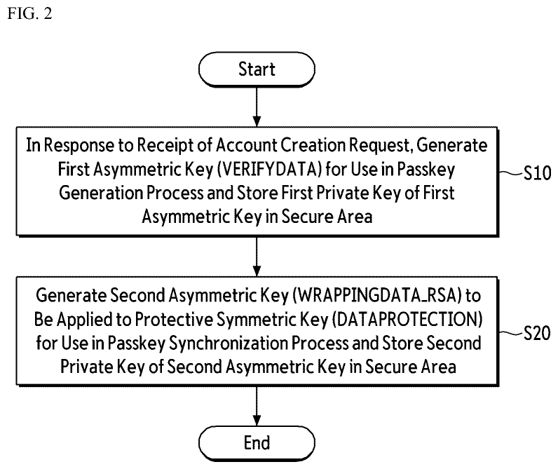

FIG. 2 is a flowchart illustrating a security management method for a passkey service according to an embodiment of the present disclosure.

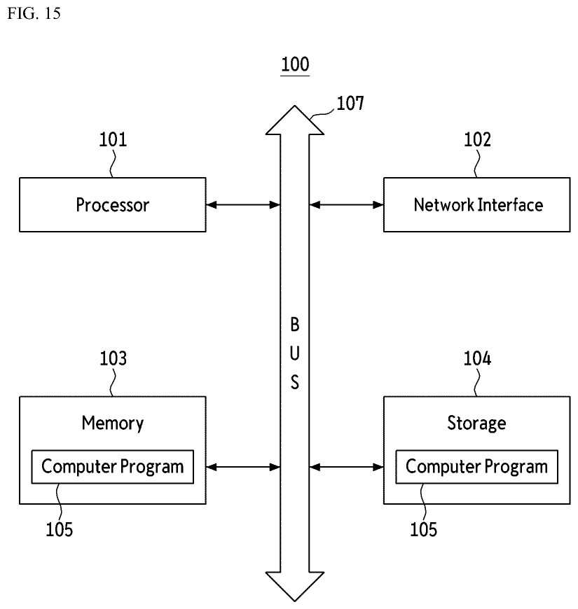

The security management method of this embodiment may be executed by any one of the user terminals 4 illustrated in FIG. 1 or by a computing device 100 illustrated in FIG. 15. The computing device 100 executing the security management method of this embodiment may be a terminal having installed thereon a service application 30 and a passkey agent 10 providing a passkey service. The computing device 100 may be, for example, a mobile terminal such as a smartphone or a tablet, or a PC. The computing device 100 may be a terminal to which an OS platform such as Android or iOS is applied.

Descriptions of a subject entity that performs some operations or steps included in the security management method of this embodiment may be omitted. In such cases, the subject entity is to be understood as the computing device 100.

Referring to FIG. 2, in step S10, when an account creation request is received from the service application 30, the passkey agent 10 of the computing device 100 generates a first asymmetric key VERIFYDATA to be used in a passkey generation process, and stores the first private key of the first asymmetric key in a secure area 40.

Thereafter, in step S20, the passkey agent 10 of the computing device 100 generates a second asymmetric key WRAPPINGDATA_RSA to be applied to a protective symmetric key DATAPROTECTION for encryption and decryption use in a passkey synchronization process, and stores the second private key of the second asymmetric key in the secure area 40.

At this time, the passkey agent 10 may deliver the first public key of the first asymmetric key and the second public key of the second asymmetric key to the passkey provider server 1.

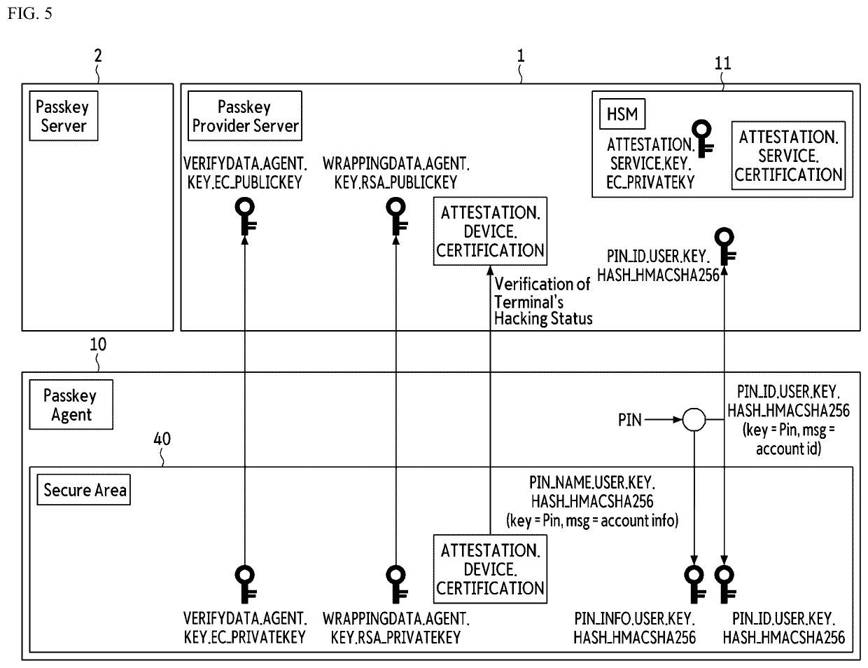

For example, referring to an exemplary key exchange process during account registration, illustrated in FIG. 5, the first private key of the first asymmetric key is VERIFYDATA.AGENT.KEY.EC_PRIVATEKEY, and the first public key of the first asymmetric key is VERIFYDATA.AGENT.KEY.EC_PUBLICKEY. Also, the second private key of the second asymmetric key is WRAPPINGDATA.AGENT.KEY.RSA_PRIVATEKEY, and the second public key of the second asymmetric key is WRAPPINGDATA.AGENT.KEY.RSA_PUBLICKEY.

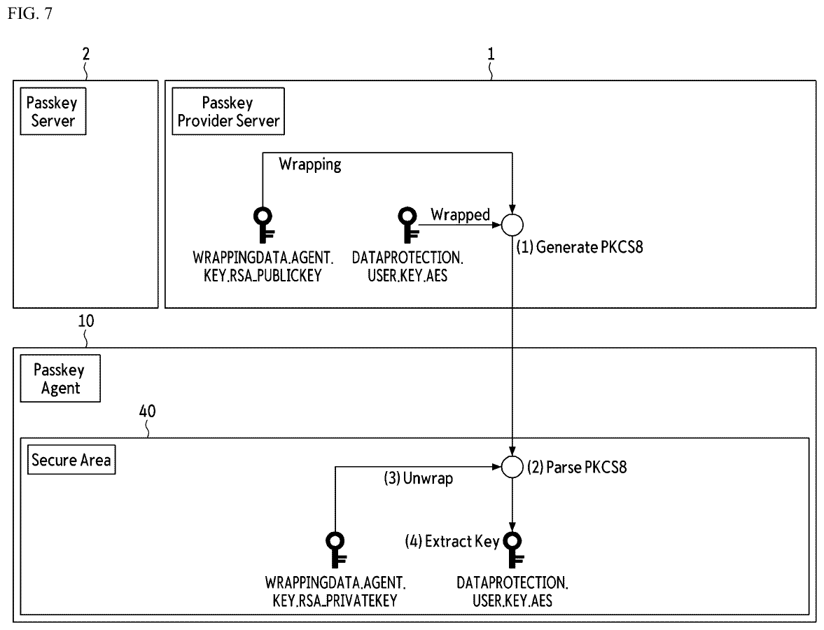

In one embodiment, the protective symmetric key, which is generated by the passkey provider server 1, may be DATAPROTECTION.USER.KEY.AES in an exemplary additional key exchange process during account registration, illustrated in FIG. 7.

In the example of FIG. 7, the passkey provider server 1 may generate a key by applying Public Key Cryptography Standards (PKCS) using the protective symmetric key DATAPROTECTION.USER.KEY.AES and the second public key of the second asymmetric key WRAPPINGDATA.AGENT.KEY.RSA_PUBLICKEY, and may deliver the generated key to the passkey agent 10.

At this time, the passkey agent 10 may retrieve the delivered key, extract the protective symmetric key DATAPROTECTION.USER.KEY.AES using the second private key WRAPPINGDATA.AGENT.KEY.RSA_PRIVATEKEY, and store the extracted key in the secure area 40.

As described above, the protective symmetric key DATAPROTECTION.USER.KEY.AES, stored on both the passkey provider server 1 and the secure area 40 of each user terminal 4, may be used during the passkey synchronization process.

In one embodiment, the passkey agent 10 may perform an additional security operation using PIN input information entered by the user.

Referring to the example in FIG. 5, the passkey agent 10 may generate a first key, PIN_INFO.USER.HASH_HMACSHA256 and a second key PIN_ID.USER.HASH_HMACSHA256 using the user's PIN input information. At this time, the first key PIN_INFO.USER.HASH_HMACSHA256 may be used for encryption during passkey synchronization to prevent the user from unlocking it, and the second key PIN_ID.USER.HASH_HMACSHA256 may be used for verification when the user registers an additional terminal. The passkey agent 10 may deliver the symmetric key of the second key to the passkey provider server 1.

As a specific example, the passkey agent 10 may deliver the second key, derived from the user's PIN input information, to the passkey provider server 1. Later, when registering a device, the passkey agent 10 may receive a PIN input from the user, and transmit a PIN ID derived from the received PIN input to the passkey provider server 1. The passkey provider server 1 then verifies whether the received PIN ID matches the previously delivered and stored second key PIN_ID.USER.HASH_HMACSHA256, and if they do not match, may trigger a device registration error. In this manner, device registration can be verified for security.

In one embodiment, in the example of FIG. 5, if a hacking attempt on the user terminal 4 is identified, the passkey agent 10 may generate an attestation ATTESTATION.DEVICE.CERTIFICATION for verifying the hacking attempt, and store it in the secure area 40, and at the same time, deliver it to the passkey provider server 1. Accordingly, the hacking status of the user terminal 4 can be verified using the device attestation stored on both the secure area 40 of the user terminal 4 and the passkey provider server 1.

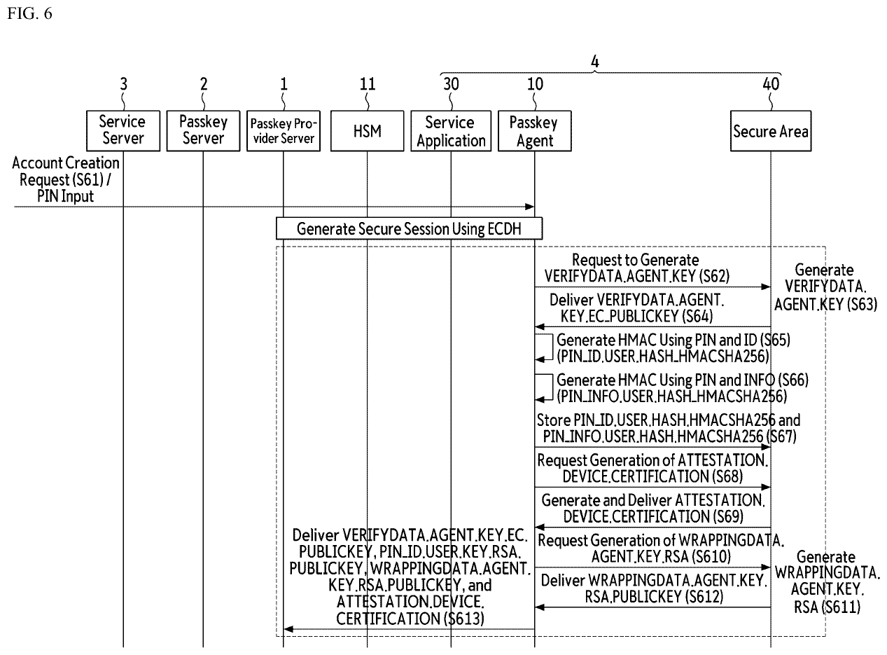

FIG. 6 illustrates a key exchange process between devices during account registration, with reference to FIG. 5.

Specifically, referring to FIG. 6, when an account creation request is received from the service application 30 (S61), the passkey agent 10 transmits a request for generating VERIFYDATA.AGENT.KEY, which is to be used in a passkey generation process, to the secure area 40 (S62), where VERIFYDATA.AGENT.KEY.PRIVATEKEY is generated and stored (S63), and then receives VERIFYDATA.AGENT.KEY.EC_PUBLICKEY from the secure area 40 (S64).

Thereafter, the passkey agent 10 generates PIN_ID.USER.HASH_HMACSHA256 using the PIN input by the user and the user's ID (S65), and generates PIN_INFO.USER.HASH_HMACSHA256 using the PIN input by the user and the user's information INFO (S66), and stores these two Hash-based Message Authentication Codes (HMACs) in the secure area 40 (S67).

Thereafter, to determine whether the user terminal 4 has been hacked, the passkey agent 10 transmits a request for generating ATTESTATION.DEVICE.CERTIFICATION to the secure area 40 (S68), and receives ATTESTATION.DEVICE.CERTIFICATION generated in the secure area 40 (S69).

In one embodiment, since an attestation key generated in a Trusted Execution Environment (TEE) space is not delivered when a hacking attempt is made, the user terminal 4 itself may generate an attestation key to determine whether it has been hacked. Additionally, an attestation certificate may be delivered to the passkey provider server 1, and certificate chain verification may be performed in conjunction with a root certificate.

Thereafter, the passkey agent 10 transmits a request for generating WRAPPINGDATA.AGENT.KEY.RSA to the secure area 40 (S610), where WRAPPINGDATA.AGENT.KEY.PRIVATEKEY is generated and stored (S611), and then receives WRAPPINGDATA.AGENT.KEY.RSA_PUBLICKEY (S612).

Thereafter, the passkey agent 10 delivers, to the passkey provider server 1, VERIFYDATA.AGENT.KEY.EC_PUBLICKEY, PIN_ID.USER.KEY.RSA_PUBLICKEY, WRAPPINGDATA.AGENT.KEY.RSA_PUBLICKEY, and ATTESTATION.DEVICE.CERTIFICATION previously generated (S613).

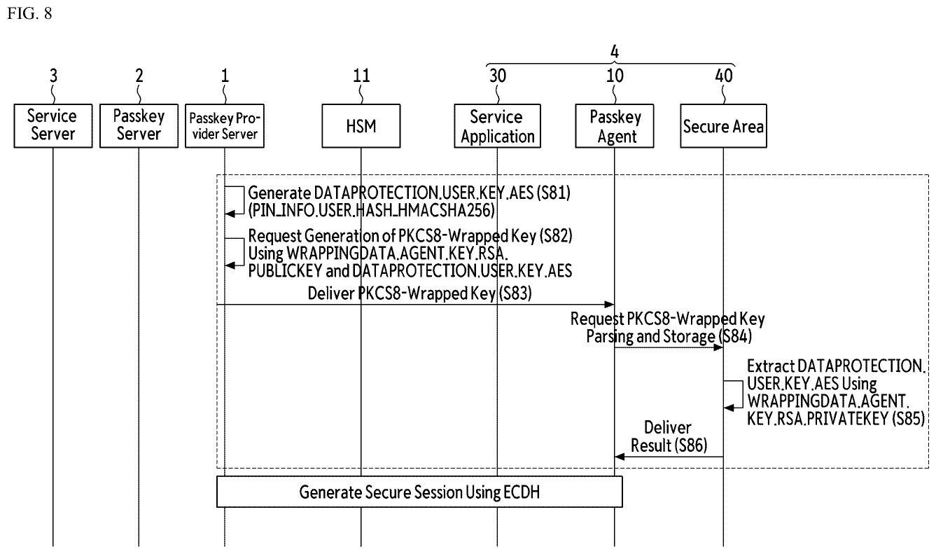

FIG. 8 illustrates a key exchange process between devices during account registration, with reference to FIG. 7.

Specifically, FIG. 8 illustrates an additional process to be performed after the process illustrated in FIG. 6.

Once the process of FIG. 6 is complete, the user terminal 4 is activated using the registered account. At this time, in FIG. 8, additional key exchange may be performed after user verification.

Specifically, the passkey provider server 1 generates DATAPROTECTION.USER.KEY.AES, a protective symmetric key to be used for encryption and decryption during the passkey synchronization process (S81).

Thereafter, the passkey provider server 1 sends a request for generation of a PKCS8-wrapped key using DATAPROTECTION.USER.KEY.AES and WRAPPINGDATA.AGENT.KEY.RSA_PUBLICKEY, previously received from the passkey agent 10 and stored (S82), and delivers a generated PKCS8-wrapped key to the passkey agent 10 (S83). Here, PKCS8 refers to Public Key Cryptography Standards #8), which is a standard technique for private key encryption.

The passkey agent 10 transmits a parsing and storage request for the received PKCS8-wrapped key to the secure area 40 (S84), and when DATAPROTECTION.USER.KEY.AES is extracted for the PKCS8-wrapped key using WRAPPINGDATA.AGENT.KEY.RSA_PRIVATEKEY in the secure area 40 (S85), the passkey agent 10 receives the extracted symmetric key, DATAPROTECTION.USER.KEY.AES (S86).

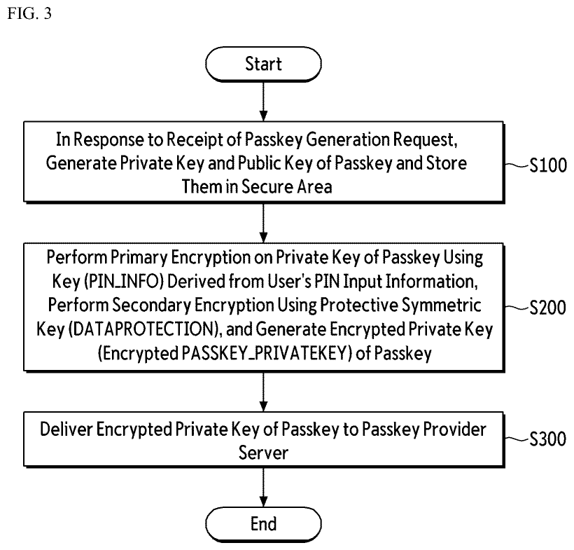

FIG. 3 is a flowchart illustrating a security management method for a passkey service according to another embodiment of the present disclosure.

The security management method of this embodiment may be executed by any one of the user terminals 4 illustrated in FIG. 1 or by the computing device 100 illustrated in FIG. 15. The computing device 100 executing the security management method of this embodiment may be a terminal on which a service application 30 and a passkey agent 10 providing a passkey service are installed. The computing device 100 may be, for example, a mobile terminal such as a smartphone or tablet, or a PC. The computing device 100 may be a terminal to which an OS platform such as Android or iOS is applied.

Descriptions of a subject entity that performs some operations or steps included in the security management method of this embodiment may be omitted. In such cases, the subject entity is to be understood as the computing device 100.

Referring to FIG. 3, in step S100, when a passkey generation request is received from the service application 30, the passkey agent 10 of the computing device 100 generates a private key and a public key of a passkey and stores the generated private and public keys in a secure area 40. The secure area 40 may be, for example, Android Keystore or iOS Keychain.

Thereafter, in step S200, the passkey agent 10 performs primary encryption on the private key PASSKEY_PRIVATEKEY using a key PIN_INFO derived from PIN input information entered by the user, and then performs secondary encryption using a protective symmetric key DATAPROTECTION previously stored in the secure area 40, thereby generating an encrypted private key Encrypted PASSKEY_PRIVATEKEY of the passkey.

Thereafter, in step S300, the passkey agent 10 delivers the encrypted private key of the passkey, generated in step S200, to the passkey provider server 1.

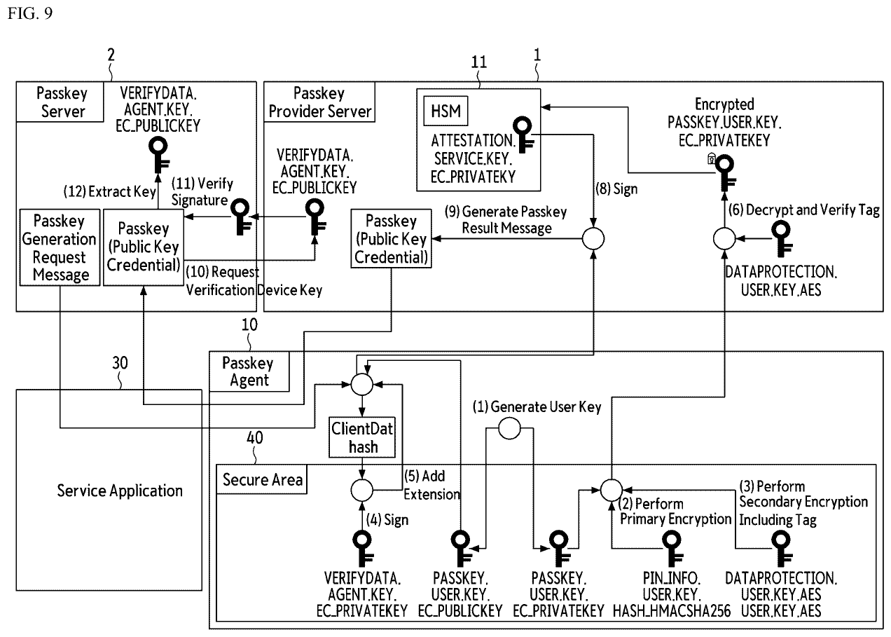

For example, referring to a key exchange process during passkey generation, illustrated in FIG. 9, the public key of the passkey is PASSKEY.USER.KEY.EC_PUBLICKEY, and the private key of the passkey is PASSKEY.USER.KEY.EC_PRIVATEKEY. Here, PASSKEY.USER.KEY.EC_PRIVATEKEY is subjected to primary encryption using a key PIN_INFO.USER.KEY.HASH_HMACSHA256 derived from the user's PIN input information, and then secondary encryption using the protective symmetric key DATAPROTECTION.USER.KEY.AES and a tag TAG.

As a result, an encrypted private key, Encrypted PASSKEY.USER.KEY.EC_PRIVATEKEY, is generated, and delivered to the passkey provider server 1.

In one embodiment, the passkey agent 10 adds the public key of the passkey, PASSKEY.USER.KEY.EC_PUBLICKEY, to the passkey generation request message, and acquires a signature value obtained by signing the hash value (ClientData hash) of data included in the passkey generation request message with VERIFYDATA.AGENT.KEY.EC_PRIVATEKEY, which has been previously stored in the secure area 40. Alternatively, the passkey agent 10 may acquire a signature value obtained by signing the challenge value (ClientData Challenge) of the data, instead of ClientData hash, with VERIFYDATA.AGENT.KEY.EC_PRIVATEKEY.

In this case, the passkey agent 10 generates an extension signature value by including the obtained signature value in an extension, and adds the generated extension signature value to the passkey generation request and delivers it to the passkey provider server 1. Here, the extension may be a format defined in the Web Authentication (WebAuthn) Application Programming Interface (API) for credentialing public keys.

In the example of FIG. 9, once decryption using DATAPROTECTION.USER.KEY.AES and verification of the tag TAG are complete, Encrypted PASSKEY.USER.KEY.EC_PRIVATEKEY, delivered to the passkey provider server 1, is stored in an HSM 11, which is a secure area.

Encrypted PASSKEY.USER.KEY.EC_PRIVATEKEY, stored in the HSM 11, is signed with a service attestation ATTESTATION.SERVICE.KEY.EC_PRIVATEKEY, and is included in a passkey result message and delivered to the passkey agent 10, which in turn may deliver the passkey result message to the service application 30.

In one embodiment, the passkey agent 10 may perform synchronization of the passkey so that user authentication may be performed using the private key of the passkey stored in the HSM 11 of the passkey provider server 1.

To this end, the passkey agent 10 may perform primary decryption on a private key delivered through the encryption of the encrypted private key Encrypted PASSKEY_PRIVATEKEY stored in the HSM 11, using the protective symmetric key DATAPROTECTION previously stored in the secure area 40, and may perform secondary decryption using a key PIN_INFO derived from the user's PIN input information.

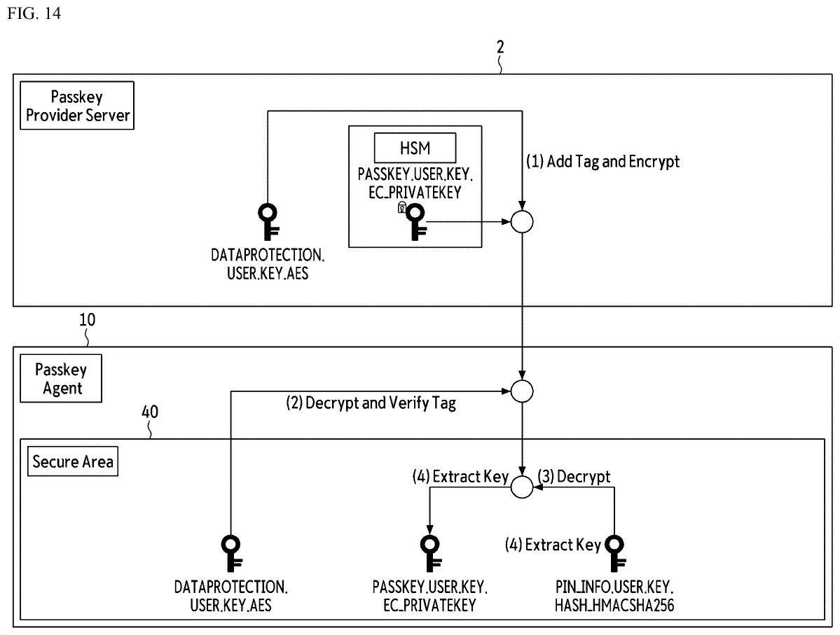

For example, referring to a key exchange process during passkey synchronization, illustrated in FIG. 14, the passkey provider server 1 encrypts PASSKEY.USER.KEY.EC_PRIVATEKEY, stored in the HSM 11, using the protective symmetric key DATAPROTECTION.USER.KEY.AES and the tag TAG, and delivers it to the passkey agent 10.

At this time, the passkey agent 10 decrypts the received encrypted private key using DATAPROTECTION.USER.KEY.AES stored in the secure area 40, performs verification of the tag TAG, and then decrypts the received encrypted private key again using PIN_INFO.USER.KEY.HASH_HMACSHA256, thereby extracting PASSKEY.USER.KEY.EC_PRIVATEKEY. As a result, passkey synchronization may be completed.

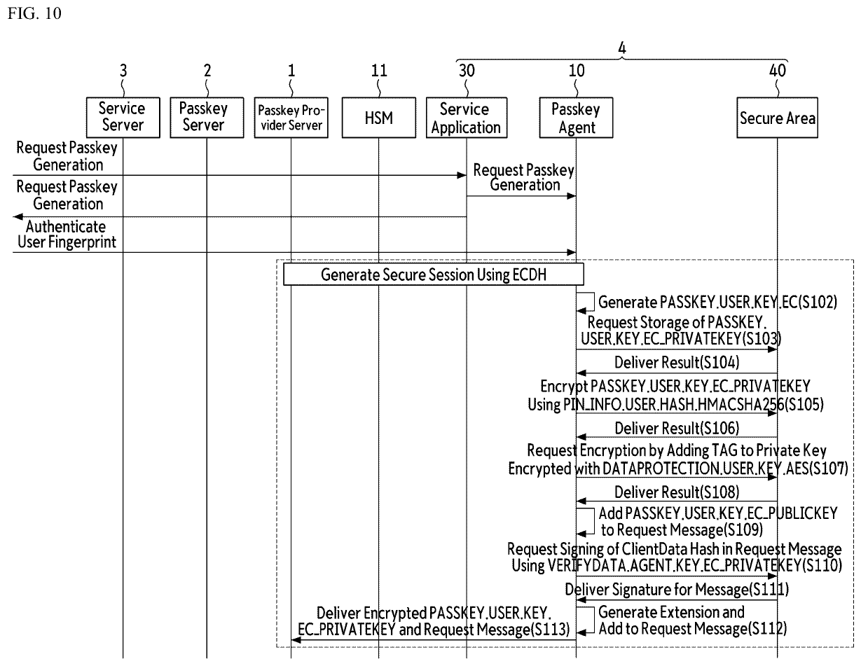

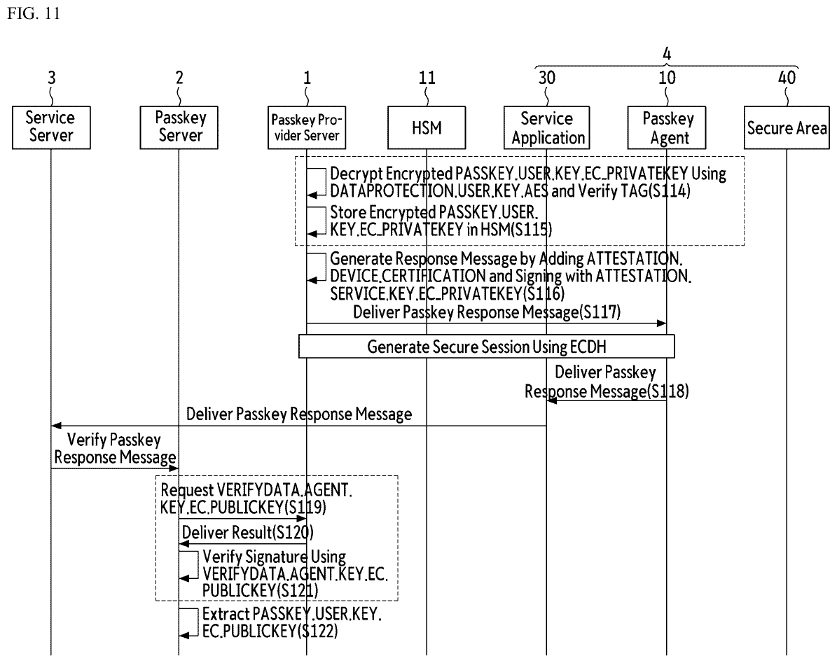

FIGS. 10 and 11 illustrate a key exchange process between devices during passkey generation, with reference to FIG. 9.

Specifically, referring to FIG. 10, when a passkey generation request is received from the service application 30 (S101), the passkey agent 10 performs fingerprint authentication of the user and then generates a passkey PASSKEY.USER.KEY.EC (S102), transmits a request for storing a private key PASSKEY.USER.KEY.EC_PRIVATEKEY of the passkey PASSKEY.USER.KEY.EC, to the secure area 40 (S103), and receives the result upon completion of the storage (S104).

Thereafter, the passkey agent 10 performs primary encryption on PASSKEY.USER.KEY.EC_PRIVATEKEY using a key PIN_INFO.USER.HASH_HMACSHA256, which is derived from the user's PIN input information (S105), receives the result (S106), and then performs secondary encryption by adding a tag TAG to the private key encrypted with DATAPROTECTION.USER.KEY.AES (S107), and receives the result (S108). Here, the tag TAG is a value recognizable in a signature value and may be a value such as PASSKEY_USER.

Thereafter, the passkey agent 10 adds PASSKEY.USER.KEY.EC_PUBLICKEY to a request message (S109), then sends a request for signing the ClientData hash of the request message with VERIFYDATA.AGENT.KEY.EC_PRIVATEKEY (S110), and receives a signature for the request message from the secure area 40 (S111).

In this case, the passkey agent 10 generates an extension and adds it to the request message (S112), and delivers the encrypted private key and the request message to the passkey provider server 1 (S113).

Thereafter, referring to FIG. 11, the passkey provider server 1 decrypts the encrypted private key using DATAPROTECTION.USER.KEY.AES and verifies the tag TAG (S114), and stores the encrypted private key in the HSM 11 (S115).

Thereafter, the passkey provider server 1 adds ATTESTATION.DEVICE.CERTIFICATION to the encrypted private key, and signs it with ATTESTATION.SERVICE.KEY.EC_PRIVATEKEY, thereby generating a passkey response message (S116).

Thereafter, when the passkey provider server 1 delivers the passkey response message to the passkey agent 10 (S117), the passkey agent 10 delivers the passkey response message to the passkey server 2 through the service application 30 and the service server 3, and the passkey server 2 performs verification of the passkey response message.

At this time, the passkey server 2 sends a request for VERIFYDATA.AGENT.KEY.EC_PUBLICKEY to the passkey provider server 1 (S119), receives the result (S120), performs signature verification using VERIFYDATA.AGENT.KEY.EC_PUBLICKEY (S121), and extracts PASSKEY.USER.KEY.EC_PUBLICKEY (S122).

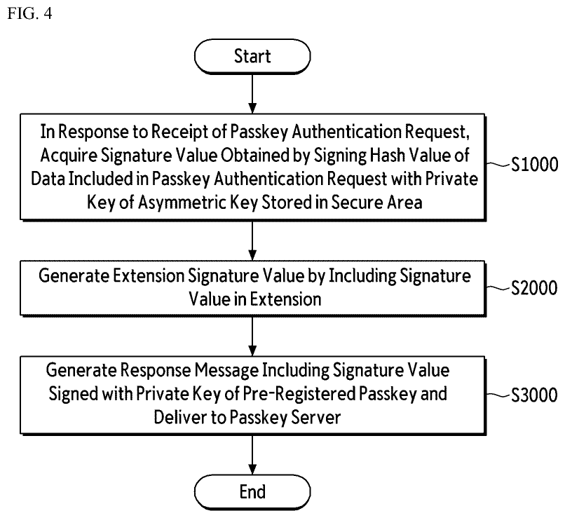

FIG. 4 is a flowchart illustrating a security management method for a passkey service according to another embodiment of the present disclosure.

The security management method of this embodiment may be executed by any one of the user terminals 4 illustrated in FIG. 1 or by the computing device 100 illustrated in FIG. 15. The computing device 100 executing the security management method of this embodiment may be a terminal on which a service application 30 and a passkey agent 10 providing a passkey service are installed. The computing device 100 may be, for example, a mobile terminal such as a smartphone or tablet, or a PC. The computing device 100 may be a terminal to which an OS platform such as Android or iOS is applied.

Descriptions of a subject entity that performs some operations or steps included in the security management method of this embodiment may be omitted. In such cases, the subject entity is to be understood as the computing device 100.

Referring to FIG. 4, in step S1000, when a passkey authentication request is received from the service application 30, the passkey agent 10 of the computing device 100 acquires a signature value obtained by signing the value of data included in the passkey authentication request with the private key of an asymmetric key VERIFYDATA previously stored in the secure area 40. At this time, the value of the data included in the passkey authentication request may be a distinguishing value that changes for each request, such as, for example, a hash or a challenge.

Thereafter, in step S2000, the passkey agent 10 generates an extension signature value by including the signature value in an extension.

Finally, in step S3000, the passkey agent 10 generates a response message including a signature value signed with the private key PASSKEY_PRIVATEKEY of a pre-registered passkey, and transmits it to the passkey server 2 through the service application 30.

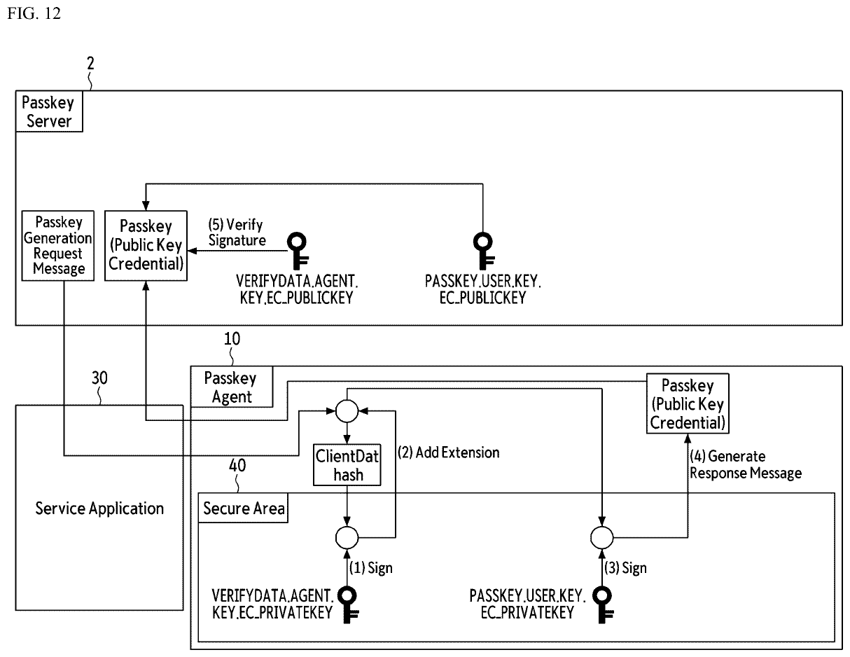

For example, referring to a key exchange process during passkey authentication, illustrated in FIG. 12, the private key of the asymmetric key previously stored in the secure area 40 is VERIFYDATA.AGENT.KEY.EC_PRIVATEKEY, and the private key of the passkey is PASSKEY.USER.KEY.EC_PRIVATEKEY. At this time, the ClientData hash included in the passkey authentication request message is signed with VERIFYDATA.AGENT.KEY.EC_PRIVATEKEY, included in the extension, and then signed with PASSKEY.USER.KEY.EC_PRIVATEKEY, thereby generating a response message. Here, the extension may be a format defined in the (WebAuthn) API for credentialing public keys.

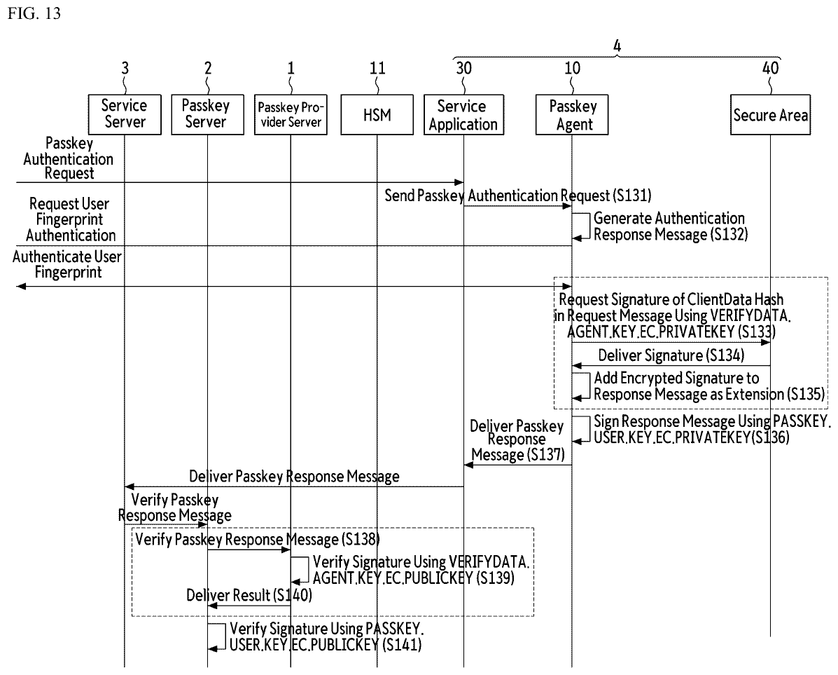

FIG. 13 illustrates a key exchange process between devices during passkey authentication, with reference to FIG. 12.

Specifically, when a passkey authentication request is received from the service application 30 (S131), the passkey agent 10 generates a passkey response message (S132).

After fingerprint authentication of the user is completed, the passkey agent 10 sends a request for signing the ClientData hash included in the passkey authentication request message with VERIFYDATA.AGENT.KEY.EC_PRIVATEKEY (S133), and receives a signature from the secure area 40 (S134).

Thereafter, the passkey agent 10 adds the encrypted signature to a passkey response message as an extension (S135), signs the passkey response message with PASSKEY.USER.KEY.EC_PRIVATEKEY (S136), and delivers the passkey response message to the passkey server 2 via the service application 30 (S137).

Thereafter, the passkey server 2 sends a request for verification of the passkey response message to the passkey provider server 1 (S138), and when signature verification with VERIFYDATA.AGENT.KEY.EC_PUBLICKEY is completed by the passkey provider server 1 (S139), the passkey server 2 receives the result (S140).

Finally, the passkey server 2 performs signature verification using PASSKEY.USER.KEY.EC_PUBLICKEY (S141).

As described above, according to this embodiment, when providing a passkey service, it is possible to provide secure key generation and key management functions using a secure area with a high level of security, such as Android Keystore, iOS Keychain, or a server-side HSM. In addition, by applying an extension to a signature during key exchange in the process of generating and authenticating a passkey, it is possible to prevent attacks through memory. Furthermore, in the process of generating and synchronizing a passkey, the level of security can be enhanced through the generation of an additional key derived from a user's PIN input information.

FIG. 15 is a hardware configuration diagram of an exemplary computing device 100.

Referring to FIG. 15, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

In one embodiment, the computer program 105 may include instructions for performing the operations of: in response to receipt of an account creation request from a service application, generating, by a passkey agent, a first asymmetric key VERIFYDATA for encryption and decryption to be used in a passkey generation process and storing a first private key of the first asymmetric key in a secure area; and generating, by the passkey agent, a second asymmetric key WRAPPINGDATA_RSA to be applied to a protective symmetric key DATAPROTECTION to be used in a passkey synchronization process, and storing a second private key of the second asymmetric key in the secure area.

In another embodiment, the computer program 105 may include instructions for performing the operations of: in response to receipt of a passkey generation request from a service application, generating, by a passkey agent, a private key PASSKEY_PRIVATEKEY and a public key PASSKEY_PUBLICKEY of a passkey and store the private and public keys in a secure area; generating, by the passkey agent, an encrypted private key Encrypted PASSKEY_PRIVATEKEY of the passkey by performing primary encryption on the private key of the passkey using a key PIN_INFO derived from a user's PIN input information and then performing secondary encryption using a protective symmetric key DATAPROTECTION previously stored in the secure area; and delivering, by the passkey agent, the encrypted private key of the passkey to a passkey provider server that communicates with the computing device 100.

In still another embodiment, a computer program 105 may include instructions for performing the operations of: in response to receipt of the passkey authentication request from a service application, acquiring, by a passkey agent, a signature value obtained by signing the value of data included in a passkey authentication request with a private key of an asymmetric key previously stored in a secure area; generating, by the passkey agent, an extension signature value by including the signature value in an extension; and generating, by the passkey agent, a response message including a signature value signed with a private key PASSKEY_PRIVATEKEY of a pre-registered passkey and transmitting the response message to a passkey server.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A security management method for a passkey service, the security management method performed by a computing device, comprising:
in response to receipt of an account creation request from a service application, generating, by a passkey agent, a first asymmetric key (VERIFYDATA) for encryption and decryption to be used in a passkey generation process, and storing a first private key of the first asymmetric key in a secure area; and
generating, by the passkey agent, a second asymmetric key (WRAPPINGDATA_RSA) to be applied to a protective symmetric key (DATAPROTECTION) to be used in a passkey synchronization process, and storing a second private key of the second asymmetric key in the secure area.

2. The security management method of claim 1, further comprising:
delivering, by the passkey agent, a first public key of the first asymmetric key and a second public key of the second asymmetric key to a passkey provider server communicating with the computing device.

3. The security management method of claim 2, wherein
the protective symmetric key is generated by the passkey provider server, and
the security management method further comprises receiving, by the passkey agent, a key generated by applying, in the passkey provider server, Public Key Cryptography Standards (PKCS) using the protective symmetric key and the second public key of the second asymmetric key, and storing the received key in the secure area.

4. The security management method of claim 2, further comprising:
storing, by the passkey agent, a first key (PIN_INFO) for encryption and a second key (PIN_ID) for verification, in the secure area, the first and second keys being generated using PIN input information of a user; and
delivering, by the passkey agent, a symmetric key of the second key to the passkey provider server.

5. The security management method of claim 1, further comprising:
generating, by the passkey agent, an attestation (Attestation.Device) for verifying whether the computing device has been hacked, when a hacking attempt on the computing device is identified, and storing the attestation in the secure area; and
delivering, by the passkey agent, the attestation to a passkey provider server.

6. A security management method for a passkey service, the security management method performed by a computing device, comprising:
in response to receipt of a passkey generation request from a service application, generating, by a passkey agent, a private key (PASSKEY_PRIVATEKEY) and a public key (PASSKEY_PUBLICKEY) of a passkey and storing the private and public keys in a secure area;
generating, by the passkey agent, an encrypted private key (Encrypted PASSKEY_PRIVATEKEY) of the passkey by performing primary encryption on the private key of the passkey using a key (PIN_INFO) derived from PIN input information of a user, and then performing secondary encryption using a protective symmetric key (DATAPROTECTION) previously stored in the secure area; and
delivering, by the passkey agent, the encrypted private key of the passkey to a passkey provider server communicating with the computing device.

7. The security management method of claim 6, further comprising:
adding, by the passkey agent, the public key of the passkey to the passkey generation request;
acquiring, by the passkey agent, a signature value obtained by signing a value of data included in the passkey generation request with a private key of an asymmetric key (VERIFYDATA) previously stored in the secure area;
generating, by the passkey agent, an extension signature value by including the signature value in an extension; and
adding, by the passkey agent, the extension signature value to the passkey generation request and delivering the passkey generation request to the passkey provider server.

8. The security management method of claim 7, wherein the extension is a format defined in a Web Authentication (WebAuthn) Application Programming Interface (API) for credentialing public keys.

9. The security management method of claim 6, further comprising:
when verification of the encrypted private key of the passkey delivered to the passkey provider server is completed, receiving, by the passkey agent, a passkey response message from the passkey provider server; and
delivering, by the passkey agent, the passkey response message to the service application,
wherein the encrypted private key of the passkey is stored in a secure area of the passkey provider server.

10. The security management method of claim 9, further comprising:
performing, by the passkey agent, primary decryption on a key delivered through encryption of the encrypted private key stored in the secure area of the passkey provider server, using the protective symmetric key previously stored in the secure area;
performing, by the passkey agent, secondary decryption using a key (PIN_INFO) derived from the PIN input information of the user; and
synchronizing the passkey through the primary and secondary decryptions.

11. A security management method for a passkey service, the security management method performed by a computing device, comprising:
in response to receipt of a passkey authentication request from a service application, acquiring, by a passkey agent, a signature value obtained by signing a value of data included in the passkey authentication request with a private key of an asymmetric key previously stored in a secure area;
generating, by the passkey agent, an extension signature value by including the signature value in an extension; and
generating, by the passkey agent, a response message including a signature value signed with a private key (PASSKEY_PRIVATEKEY) of a pre-registered passkey and transmitting the response message to a passkey server.

12. The security management method of claim 11, wherein the signature value included in the response message delivered to the passkey server is verified using a public key of an asymmetric key (VERIFYDATA) previously stored in a passkey provider server.

13. A computing device, comprising:
at least one processor;
a memory for loading a computer program executed by the at least one processor; and
a storage for storing the computer program,
wherein the computer program includes instructions for performing operations of: in response to receipt of an account creation request from a service application, generating, by a passkey agent, a first asymmetric key (VERIFYDATA) for encryption and decryption to be used in a passkey generation process and storing a first private key of the first asymmetric key in a secure area; and generating, by the passkey agent, a second asymmetric key (WRAPPINGDATA_RSA) to be applied to a protective symmetric key (DATAPROTECTION) to be used in a passkey synchronization process, and storing a second private key of the second asymmetric key in the secure area.

14. The computing device of claim 13, wherein the computer program further includes instructions for performing an operation of delivering, by the passkey agent, a first public key of the first asymmetric key and a second public key of the second asymmetric key to a passkey provider server communicating with the computing device.

15. The computing device of claim 14, wherein
the protective symmetric key is generated by the passkey provider server, and
the computer program further includes instructions for performing an operation of receiving, by the passkey agent, a key generated by applying, in the passkey provider server, Public Key Cryptography Standards (PKCS) using the protective symmetric key and the second public key of the second asymmetric key, and storing the received key in the secure area.

16. The computing device of claim 14, wherein the computer program further includes instructions for performing operations of: storing, by the passkey agent, a first key PIN_INFO for encryption and a second key PIN_ID for verification, in the secure area, the first and second keys being generated using PIN input information of a user; and delivering, by the passkey agent, a symmetric key of the second key to the passkey provider server.

17. The computing device of claim 13, wherein the computer program further includes instructions for performing operations of: generating, by the passkey agent, an attestation (Attestation.Device) for verifying whether the computing device has been hacked, when a hacking attempt on the computing device is identified, and storing the attestation in the secure area; and delivering, by the passkey agent, the attestation to a passkey provider server.
